(19) United States
(12) Patent Application Publication
(10) Pub. No.: US 2017/0023073 A1
(43) Pub. Date: Jan. 26, 2017

(54) ONE-WAY CLUTCH

(71) Applicant: Caterpillar Inc., Peoria, IL (US)

(72) Inventor: Edward De Jesus Rivera, Peoria, IL (US)

(73) Assignee: Caterpillar Inc., Peoria, IL (US)

(21) Appl. No.: 15/289,841

(22) Filed: Oct. 10, 2016

(51) Int. Cl. F16D 41/06; F16H 41/24

(52) U.S. Cl. CPC F16D 41/06; F16H 41/24; F16D 2041/0605; F16D 43/02

(57) ABSTRACT

A one-way clutch is provided. The one-way clutch includes an outer cam having a plurality of notches. Each of the plurality of notches is circumferentially spaced along an inner periphery of the outer cam. The one-way clutch also includes an inner race positioned coaxially within the outer cam. The inner race includes a plurality of pockets circumferentially spaced along an outer periphery of the inner race. The one-way clutch further includes a clutch mechanism. The clutch mechanism includes a plurality of leaf springs coupled to each of the plurality of notches. Each of the plurality of leaf springs is adapted to lock the outer cam and the inner race in first direction, and to slide on the outer periphery of the inner race in a second direction. The second direction is opposite to the first direction.

### TECHNICAL FIELD

The present disclosure relates to a clutch, and more particularly to a one-way clutch for use with a stator in a torque converter.

### BACKGROUND

A transmission system associated with a machine, such as an off-highway vehicle, transmits power generated by a power source to ground engaging members. The transmission system includes a torque converter having a stator and a one-way clutch positioned within the stator. The one-way clutch includes an outer cam and an inner race.

Traditional one-way clutches include at least one roller and a spring to lock the outer cam with the inner race so that the outer cam and the inner race rotate together in one direction. Further, in an unlocked state of the one-way clutch, the outer cam or the inner race is free to spin at different speeds including opposite direction. These designs of the one-way clutches tend to experience roller skewing, roller float, and spring crushing which are undesirable. The skewing of the rollers occurs when an axis of the roller is not parallel to an axis of rotation. Such an event may cause inconsistent rotation of the outer cam and the inner race, which may reduce the overall efficiency of the torque converter.

U.S. Pat. No. 7,296,668, hereinafter referred to as '668 patent, describes an overrunning clutch which includes a first and a second clutch members. The first and second clutch members include coupling faces between which spring biased pivotal struts and locking formations cooperate to prevent relative rotation in only one direction. The overrunning clutch includes a snap ring and a thrust plate which cooperate with one another to axially secure the clutch members to each other. The thrust plate includes a retainer which projects from the thrust plate to prevent rotation. The retainer is received between ends of the snap ring to prevent thrust plate rotation. However, the '668 patent does not describe any functional or design solution to reduce problems, such as, roller skewing, roller float, and spring crushing.

### SUMMARY OF THE DISCLOSURE

In one aspect of the present disclosure, a one-way clutch is provided. The one-way clutch includes an outer cam having a plurality of notches. Each of the plurality of notches is circumferentially spaced along an inner periphery of the outer cam. The one-way clutch also includes an inner race positioned coaxially within the outer cam. The inner race includes a plurality of pockets circumferentially spaced along an outer periphery of the inner race. The one-way clutch further includes a clutch mechanism. The clutch mechanism includes a plurality of leaf springs coupled to each of the plurality of notches. Each of the plurality of leaf springs is adapted to selectively slide into at least one of the plurality of pockets for locking the outer cam and the inner race in a first direction. Each of the plurality of leaf springs is also adapted to selectively slide along the outer periphery of the inner race for unlocking the outer cam and the inner race to allow at least one of the outer cam and the inner race, or both, to spin freely in a second direction. The second direction is opposite to the first direction.

In another aspect of the present disclosure, a one-way clutch is provided. The one-way clutch includes an outer cam having a plurality of notches. Each of the plurality of notches is circumferentially spaced along an inner periphery of the outer cam. Each of the plurality of notches include a first notch surface. Each of the plurality of notches also include a second notch surface. The second notch surface is provided adjacent to the first notch surface. Each of the plurality of notches further includes a pair of first holes. The pair of first holes are disposed on the second notch surface. The one-way clutch also includes an inner race. The inner race is positioned coaxially within the outer cam. The inner race includes a plurality of pockets circumferentially spaced along an outer periphery of the inner race. Each of the plurality of pockets include a concave race surface. Each of the plurality of pockets also include a contact race surface. The contact race surface is defined adjacent to the concave race surface. Each of the plurality of pockets further include a convex race surface. The convex race surface is defined adjacent to the concave race surface and the contact race surface. The one-way clutch further includes a clutch mechanism. The clutch mechanism includes a plurality of leaf springs coupled to the plurality of notches via a plurality of fastening members. Each of the plurality of leaf springs include a first spring surface. Each of the plurality of leaf springs also includes a second spring surface. The second spring surface is opposite to the first spring surface. Each of the plurality of leaf springs further include a pair of second holes. The pair of second holes extend between the first spring surface and the second spring surface. The pair of second holes are adapted to receive the plurality of fastening members therethrough. Each of plurality of leaf springs includes a first reaction surface. The first reaction surface is adapted to abut the first notch surface of each of the plurality of notches. Each of the plurality of leaf springs also include a second reaction surface. The second reaction surface is disposed opposite to the first reaction surface. The second reaction surface is adapted to engage with the concave race surface of the inner race.

Other features and aspects of this disclosure will be apparent from the following description and the accompanying drawings.

### BRIEF DESCRIPTION OF THE DRAWINGS

FIG. 1 is a cross-sectional view of a portion of an exemplary torque converter, according to various concepts of the present disclosure;

FIG. 2 is a front view of a one-way clutch of the torque converter of FIG. 1 in a locked state, according to various concepts of the present disclosure;

FIG. 3 is a perspective sectional view of a portion of the one-way clutch of FIG. 2, according to various concepts of the present disclosure;

FIG. 4 is a perspective view of a portion of an outer cam of the one-way clutch of FIG. 2, according to various concepts of the present disclosure;

FIG. 5 is a perspective view of a leaf spring associated with the one-way clutch of FIG. 2, according to various concepts of the present disclosure; and

FIG. 6 is a front view of the one-way clutch of the torque converter of FIG. 1 in an unlocked state, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

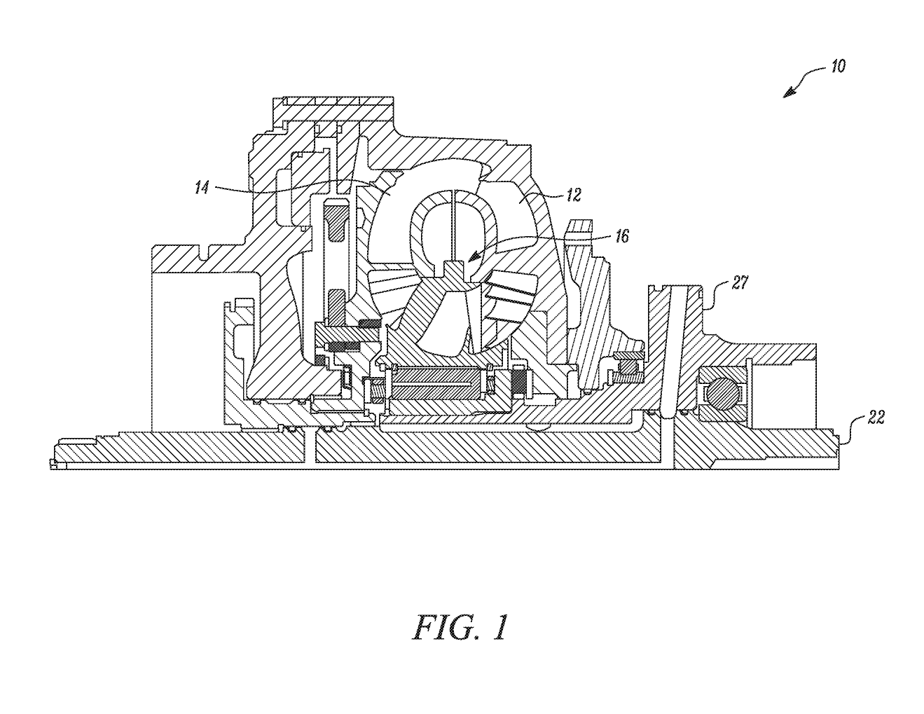

Referring to FIG. 1, an exemplary torque converter assembly 10 is depicted. The torque converter assembly 10 is used to transfer power between a power source (not shown) and a transmission system (not shown) of a machine (not shown). The machine may be a stationary machine or a mobile machine associated with an industry such as, mining, construction, farming, transportation, or any other industry known in the art. The machine may be an earth moving machine, such as a wheel loader, an off-highway truck, a motor grader, or any other suitable earth moving machine. The machine may also be an on-highway truck, a passenger vehicle, etc.

The power source produces a power output to provide motive force to the machine. The power source may embody an internal combustion engine, such as a diesel engine, a gasoline engine, a gaseous fuel-powered engine, or any other combustion engine. The power source may alternatively embody an electric motor coupled to a generator or some other source of electrical power. Further, the transmission system may include numerous components that assist in transmitting power from the power source to a set of ground engaging members not shown) of the machine. In the illustrated example, the transmission system is embodied as an automatic transmission. Alternatively, the transmission system may include a manual transmission, without limiting the scope of the disclosure.

The torque converter assembly 10 includes an impeller 12 and a turbine 14. Further, a stator assembly 16 is positioned between the impeller 12 and the turbine 14. The impeller 12 rotates as a result of a rotational power input received from the power source. The rotation of the impeller 12 imparts a momentum to a fluid introduced in the impeller 12. The momentum of the fluid in turn causes a turbine shaft 22 of the turbine 14, and subsequently, the transmission system to rotate. In one example, the fluid is a hydraulic fluid.

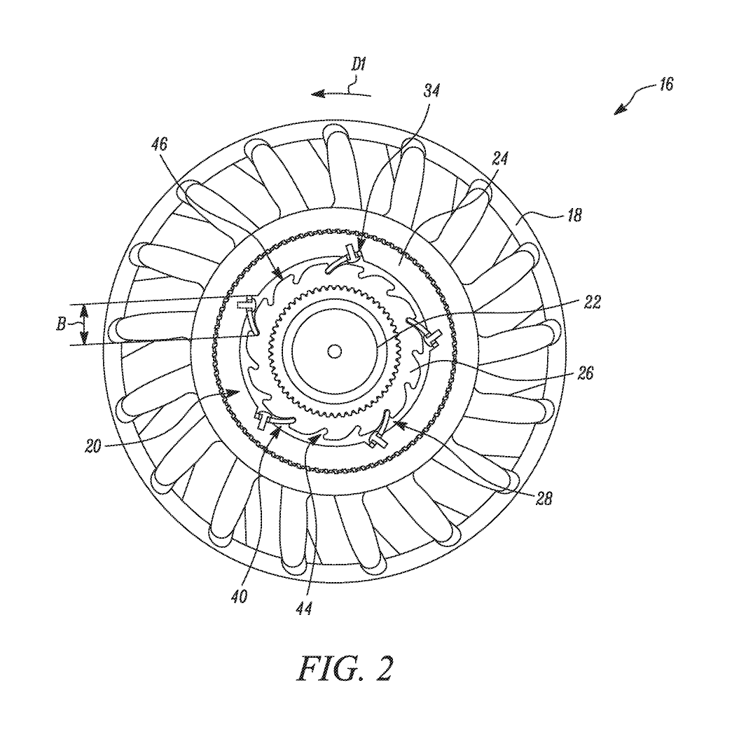

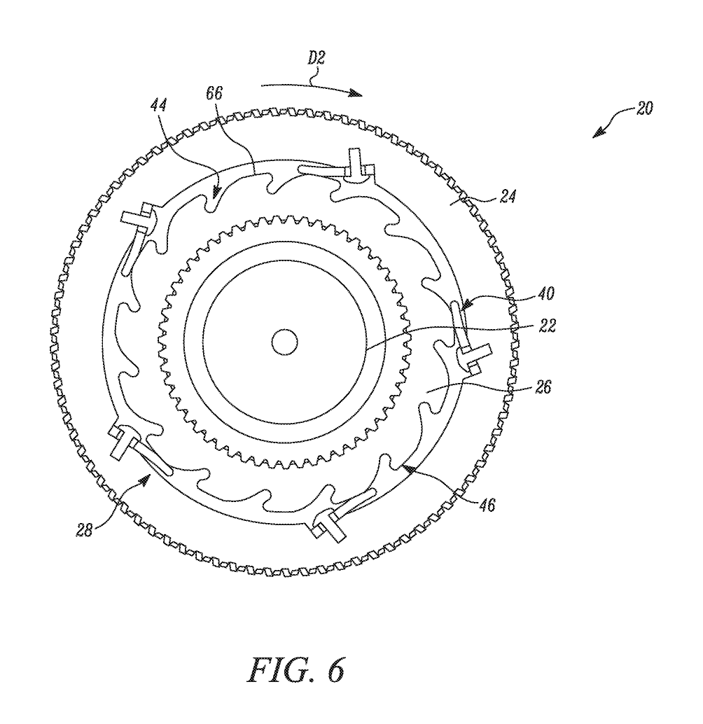

Referring to FIG. 2, the stator assembly 16 includes a stator 18 and a one-way clutch 20. The stator 18 is connected to an inner race 26 via the one-way clutch 20. In the illustrated example, the one-way clutch 20 allows locking of the stator 18 to prevent rotation of the stator 18 in a first direction “D1”. In this example, the first direction “D1” is embodied as a counter-clockwise direction. Further, the one-way clutch 20 allows the stator 18 to rotate or spin independent of the inner race 26 in a second direction “D2” (see FIG. 6). The second direction “D2” is opposite to the first direction “D1”. In this example, the second direction “D2” is embodied as a clockwise direction.

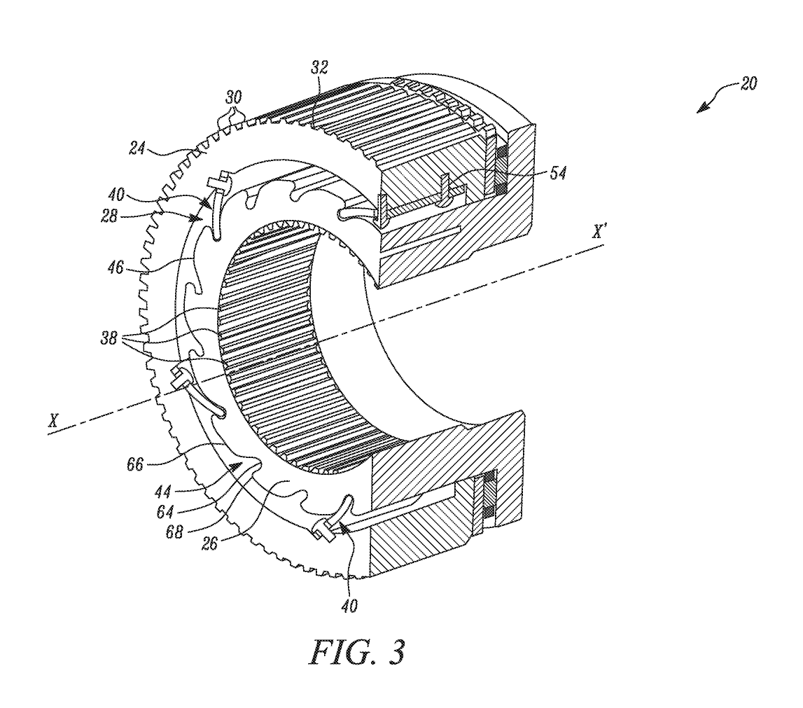

Referring to FIG. 3, the one-way clutch 20 includes an outer cam 24. In the illustrated example, the outer cam 24 is embodied as a spinning outer cam. The outer cam 24 includes a number of external splines 30. The external splines 30 are provided on an outer periphery 32 of the outer cam 24. The external splines 30 are received within internal splines (not shown) of the stator 18 to connect the outer cam 24 with the stator 18.

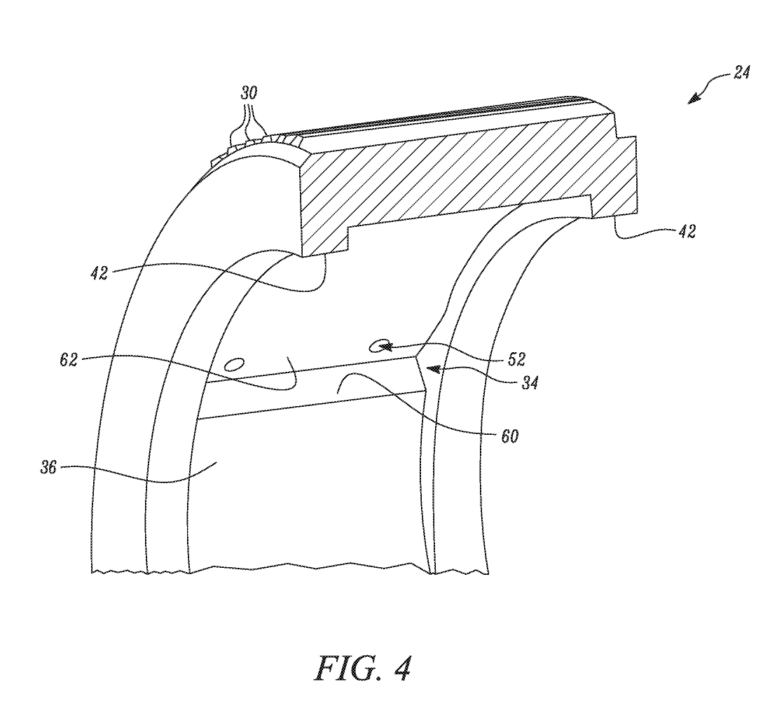

Referring to FIG. 4, the outer cam 24 includes a number of notches 34. The notches 34 are circumferentially spaced along an inner periphery 36 of the outer cam 24. In the illustrated example, the outer cam 24 includes five notches 34 (see FIG. 2). Alternatively, the outer cam 24 may include more than five notches 34, without limiting the scope of the disclosure. The number of notches 34 may vary based on a size of the torque converter assembly 10. Each of the notches 34 includes a first notch surface 60 and a second notch surface 62. The second notch surface 62 is provided adjacent to the first notch surface 60. A pair of first holes 52 are disposed on the second notch surface 62 of the outer cam 24. The outer cam 24 define a pair of pilot surfaces 42. The pair of pilot surfaces 42 may include any type of bearing or plain surface.

Referring to FIG. 3, the one-way clutch 20 includes the inner race 26. In the illustrated example, the inner race 26 is embodied as a stationary inner race. The inner race 26 is coaxially disposed within the outer cam 24. More particularly, the inner race 26 and the outer cam 24 are coaxially disposed on the turbine shaft 22 along an axis X-X′. The inner race 26 is coupled to a stator carrier 27 (shown in FIG. 1). A number of internal splines 38 of the inner race 26 are received within a number of external splines (not shown) on the stator carrier 27 in order to couple the inner race 26 with the stator carrier 27.

The inner race 26 includes a number of pockets 44 circumferentially spaced along an outer periphery 46 of the inner race 26. The pockets 44 include a concave race surface 64 and a contact race surface 66. The contact race surface 66 is defined adjacent to the concave race surface 64. The pockets 44 includes a convex race surface 68. The convex race surface 68 is defined adjacent to the concave race surface 64 and the contact race surface 66. In the illustrated embodiment, the inner race 26 includes fifteen pockets 44. Alternatively, the inner race 26 may include any number of pockets 44, without limiting the scope of the disclosure.

The one-way clutch 20 includes a clutch mechanism 28. The clutch mechanism 28 is provided between the outer cam 24 and the inner race 26. The clutch mechanism 28 engages the outer cam 24 with the inner race 26 to lock the outer cam 24 and the inner race 26. Further, the clutch mechanism 28 disengages the outer cam 24 and the inner race 26 to unlock the outer cam 24 and the inner race 26.

The clutch mechanism 28 includes a number of leaf springs 40 provided within the notches 34 of the outer cam 24. The leaf springs 40 selectively lock the outer cam 24 with the inner race 26 to prevent a rotation of the outer cam 24 in the first direction “D1”. Alternatively, the leaf springs 40 selectively unlock the outer cam 24 and the inner race 26 to allow the outer cam 24 to spin freely in the second direction “D2”. The leaf springs 40 are provided between the inner periphery 36 of the outer cam 24 and the outer periphery 46 of the inner race 26.

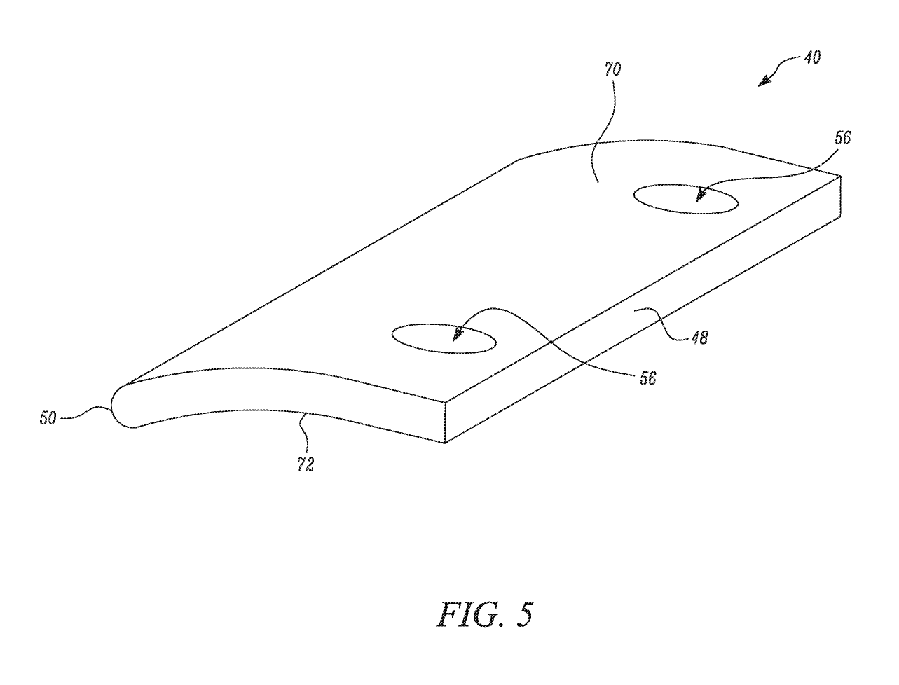

Referring to FIG. 5, each of the leaf springs 40 includes a first spring surface 70 and a second spring surface 72. The second spring surface 72 is opposite to the first spring surface 70. Each of the leaf springs 40 includes a pair of second holes 56. The pair of second holes 56 extend between the first spring surface 70 and the second spring surface 72. Further, each of the leaf springs 40 includes a first reaction surface 48 and a second reaction surface 50. The second reaction surface 50 is opposite to the first reaction surface 48. The first reaction surface 48 is received into the notch 34 (see FIG. 2) of the outer cam 24. More particularly, the first reaction surface 48 abuts the first notch surface 60 (see FIG. 4) of the notch 34. Further, the second reaction surface 50 selectively contacts the pockets 44 (see FIG. 2) of the inner race 26. More particularly, the second reaction surface 50 engages with the concave race surface 64 (see FIG. 3) of the inner race 26. In the illustrated embodiment, the clutch mechanism 28 includes five leaf springs 40 (see FIG. 2) corresponding to the number of notches 34. Alternatively, the number of leaf springs 40 may vary based on the application.

Referring now to FIG. 3, the clutch mechanism 28 includes a number of fastening members 54. The fastening members 54 couple each of the leaf springs 40 within the respective notch 34 of the outer cam 24. The fastening members 54 may include, but not limited to, rivets, screws, bolts etc., without limiting the scope of the disclosure. The first holes 52 (see FIG. 4) are aligned with the second holes 56 (see FIG. 5) to receive the fastening members 54. In some examples, the fastening members 54 may include threads that engage with threads provided in the holes 52, 56 for coupling of each of the leaf springs 40 within the respective notch 34. Alternatively, the fastening members 54 may embody weld studs that may be welded to the notches 34 for coupling each of the leaf springs 40 within the respective notch 34. In one example, each of the leaf springs 40 may be directly welded, brazed, or soldered to the respective notch 34, without any limitations. During operation, the leaf springs 40 may selectively engage within the pockets 44 provided on the inner race 26. Hence a thickness of the leaf springs 40 may correspond to dimensions of the pockets 44 provided on the inner race 26.

The clutch mechanism 28 of the one-way clutch 20 prevents the rotation of the outer cam 24 in the first direction “D1”. Further, the clutch mechanism 28 allows spinning of the outer cam 24 in the second direction “D2”. As shown in FIG. 2, in order to prevent the rotation of the outer cam 24 in the first direction “D1”, the clutch mechanism 28 locks the outer cam 24 with the inner race 26. Based on the flow of the fluid in the first direction “D1”, the outer cam 24 along with the leaf springs 40 slides into the pockets 44 and locks the outer cam 24 with the inner race 26 to prevent the rotation of the outer cam 24 in the first direction “D1”. A buckling force “B” causes each of the leaf springs 40 to remain engaged within the respective pockets 44 of the inner race 26, locking the outer cam 24 and the inner race 26 by applying a load along a buckling direction thereof. Hence, the outer cam 24 is locked with the inner race 26 preventing rotation of the outer cam 24 in the first direction “D1”.

As shown in FIG. 6, in order to allow the outer cam 24 to spin freely in the second direction “D2”, the clutch mechanism 28 unlocks the outer cam 24 and the inner race 26. More particularly, based on the flow of the fluid in the second direction “D2”, the outer cam 24 along with the leaf springs 40 rotate in the second direction “D2”, thereby causing the leaf springs 40 to bend and slide over the respective contact race surfaces 66 of the inner race 26. The sliding of the leaf springs 40 over the respective contact race surfaces 66 of the inner race 26 unlocks the outer cam 24 and the inner race 26, thereby allowing the outer cam 24 to spin freely in the second direction “D2”.

### INDUSTRIAL APPLICABILITY

The present disclosure relates to the one-way clutch 20 that may be used in torque converter assemblies. Further, the one-way clutch 20 may be used in other applications that include one-way clutches, without limiting the scope of the present disclosure. Accordingly, the one-way clutch 20 may be utilized in a number of configurations, according to system requirements. The configurations may include any one of a spinning inner race with a stationary outer cam, a spinning outer cam with a stationary inner race, or the spinning inner race and the spinning outer cam, without any limitations. In various applications, the clutch mechanism 28 may lock the outer cam 24 and the inner race 26 to allow rotation of the outer cam 24 and the inner race 26 in the first direction “D1”. Further, the clutch mechanism 28 may unlock the outer cam 24 and the inner race 26 to allow spinning of the outer cam 24, the inner race 26, or both, in the second direction “D2”.

The number of leaf springs 40 of the one-way clutch 20 selectively locks the outer cam 24 and the inner race 26 in one direction. Further, the number of leaf springs 40 selectively unlocks the outer cam 24 and the inner race 26 to allow the outer cam 24, the inner race 26, or both, to spin freely at different speeds including opposite direction. The present disclosure provides a simple and ergonomic design of the one-way clutch 20. Further, as the one-way clutch 20 does not include rollers, problems associated with skewing of the rollers may be eliminated. Further, the pair of pilot surfaces 42 of the outer cam 24 may ensure that the system rotates in a concentric mode.

The one-way clutch 20 locks the stator 18 in one direction, and allows spinning of the stator 18 in another direction. In operation, the outer cam 24 is allowed to spin freely in the second direction “D2”, whereas the outer cam 24 and the inner race 26 lock with one another in the first direction “D1” to prevent the rotation of the outer cam 24 in the first direction “D1”. This feature of the stator 18 provided by the one-way clutch 20 may increase efficiency gains and also increase an amount of power supplied to the transmission system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A one-way clutch comprising:
an outer cam having a plurality of notches, wherein each of the plurality of notches is circumferentially spaced along an inner periphery of the outer cam;
an inner race positioned coaxially within the outer cam, wherein the inner race includes a plurality of pockets circumferentially spaced along an outer periphery of the inner race; and
a clutch mechanism including a plurality of leaf springs coupled to each of the plurality of notches, wherein each of the plurality of leaf springs is adapted to:
selectively slide into at least one of the plurality of pockets for locking the outer cam and the inner race in a first direction; and
selectively slide along the outer periphery of the inner race for unlocking the outer cam and the inner race to allow at least one of the outer cam and the inner race, or both, to spin freely in a second direction, wherein the second direction is opposite to the first direction.

2. A one-way clutch comprising:
an outer cam having a plurality of notches, wherein each of the plurality of notches is circumferentially spaced along an inner periphery of the outer cam, each of the plurality of notches including:
a first notch surface;
a second notch surface, wherein the second notch surface is provided adjacent to the first notch surface; and
a pair of first holes disposed on the second notch surface;
an inner race positioned coaxially within the outer cam, wherein the inner race includes a plurality of pockets circumferentially spaced along an outer periphery of the inner race, each of the plurality of pockets includes:
a concave race surface;
a contact race surface defined adjacent to the concave race surface; and
a convex race surface defined adjacent to the concave race surface and the contact race surface; and
a clutch mechanism including a plurality of leaf springs coupled to the plurality of notches via a plurality of fastening members, wherein each of the plurality of leaf springs includes:
a first spring surface;
a second spring surface, wherein the second spring surface is opposite to the first spring surface;
a pair of second holes extending between the first spring surface and the second spring surface, the pair of second holes adapted to receive the plurality of fastening members therethrough;
a first reaction surface adapted to abut the first notch surface of each of the plurality of notches; and
a second reaction surface, wherein the second reaction surface is disposed opposite to the first reaction surface, and wherein the second reaction surface is adapted to engage with the concave race surface of the inner race.
